(19) United States
(12) Patent Application Publication
(10) Pub. No.: US 2021/0109248 A1
(43) Pub. Date: Apr. 15, 2021

(54) SYSTEM, METHOD, AND DEVICE FOR REAL-TIME SINKHOLE DETECTION

(71) Applicant: Sophia Wang, Woodbridge, CT (US)

(72) Inventor: Sophia Wang, Woodbridge, CT (US)

(21) Appl. No.: 16/869,527

(22) Filed: May 7, 2020

Related U.S. Application Data
(60) Provisional application No. 62/842,693, filed on May 3, 2019.

(51) Int. Cl. G01V 7/06; G06F 17/13; G06N 20/00; H04W 84/18; H04L 29/08

(52) U.S. Cl. CPC G01V 7/06; G06F 17/13; H04L 67/12; H04W 84/18; G06N 20/00

(57) ABSTRACT

A system for real-time sinkhole detection comprises a plurality of measuring devices, a network system, and an analysis system. The plurality of measuring devices include a plurality of sensors, wherein each of the plurality sensors is configured to record, process and compile spatial data into a data set. The network system is configured to electronically collect a plurality of the data sets from each of the plurality of sensors. The analysis system comprises an electronic database system and a server. The server is configured to electronically transmit the plurality of the data sets to the electronic database system; query the data set from the electronic database system; process the data set by applying a machine learning algorithm to generate a real-time result about sinkhole detection; transmit the real-time result to an interface system; and update the electronic database system by transmitting the real-time result back to the electronic database system.

### CROSS REFERENCE TO RELATED APPLICATIONS

This application claims priority to, and the benefit of, U.S. Provisional Application No. 62/842,693 filed May 3, 2019, the contents of which are incorporated by reference herein in their entirety.

### FIELD OF INVENTION

Exemplary embodiments of the present disclosure relate to a system, method and device for real-time sinkhole detection.

### BACKGROUND

### 1. Brief Description of the Art

Sinkholes are defined as small closed depressions in karst, also known as dolines (Waltham, Antony Clive, et al. “Glossary of Sinkhole Terminology.” Sinkholes and Subsidence: Karst and Cavernous Rocks in Engineering and Construction, Springer, 2005, pp. 31). The composition and geology of karst landscapes are important variables to consider when determining the geography, topography, and formation of sinkholes. Karst landscapes are typically made up of limestone, a soft rock that dissolves in water. Limestone is composed of calcium carbonate shells and skeletons from marine organisms, and thus, limestone commonly forms in warm, moist marine environments (King, Hobart M. “Limestone.” Geology, Geology.com, geology.com/rocks/limestone.shtml.In-text Citation). Regions with high limestone content can indicate regions that are particularly susceptible to sinkhole activity, such as Florida, USA.

The six types of sinkholes are solution (of bedrock), bedrock collapse, cap-rock collapse, cover collapse (also named dropout), suffosion, and buried (Currens, James. “Hypothesized Mechanism for the Initiation of Soil Cavities and Subsequent Cover-Collapse in Karst Terrain.” Journal of Cave and Karst Studies, vol. 80, no. 4, 2018, pp. 172-180., doi:10.4311/2016es0148). In the United States, the most common type of sinkhole is the cover collapse sinkhole. Cover collapse sinkholes are caused by water tables dissolving limestone and bedrock foundations of a landscape. The water tables oftentimes flow through limestone layers and create joints and small speleological features, such as caves. Gradually, the void and cavity grow large enough to eventually collapse the overlying soil cover of clay and sand (The Florida Speleological Society. “Karst Terrain.” Basic Central Florida Geology). The cover-collapse sinkhole is often perceived as an event that occurs without warning, however, the formation itself is a gradual process. Oftentimes, the sinkhole formation process spans over several months to years.

Cover collapse sinkholes occur frequently in Florida, USA, because of the vast limestone foundations in the landscape as well as weather and human activity that trigger sinkholes. Florida is underlain by thick sequences of limestone, dolostone, and sand. The combination of limestone and sand is a major contributor in the formation of Florida's groundwater reservoir, as the difference in mesh creates a system that can easily trap groundwater (Florida Geological Survey. “Geologic Map of the State of Florida.” Geology). This same characteristic, however, increases the amount of water tables involved in sinkhole formation. Throughout Florida, the large limestone tracts are not visible, but are instead covered by either a thin overburden of sand and clay or a thick overburden with water tables and piezometric surfaces, making sinkhole formation difficult to visualize. In Central Florida, the land is covered by thin to moderate overburden and has a well-developed karst landscape (The Florida Speleological Society. “Karst Terrain.” Basic Central Florida Geology). The landscape composition makes this particular region most susceptible to sinkhole activity compared to Northern Florida, as shown in a Figure entitled “Florida Geologic Map Data” from a Geographic Information Systems (GIS) database from the United States Geological Survey (USGS) (Florida Geologic Map Data, Interactive Maps and Downloadable Data for Regional and Global Geology, Geochemistry, Geophysics, and Mineral Resources; Products of the USGS Mineral Resources Program, mrdata.usgs.gov/geology/state/state.php?state=FL). Northern Florida mainly consists of cohesive clay-like sediments of low permeability and discontinuous carbonate beds.

Sinkholes are naturally occurring events, however, they are oftentimes expedited or triggered by human activity. The impact of mining has been observed since 1950. In Shelby County, Alabama, from 1958 to 1973, 1,000 sinkholes developed from dewatering in carbonate rocks by wells, quarrying and mining operations and through surface drainage changes (Currens, James. “Cover-Collapse Sinkholes in Kentucky, USA: Geographic and Temporal Distribution.” Carbonates & Evaporites, vol. 27, no. 2, June 2012, p. 137. EBSCOhost, doi:10.1007/s13146-012-0097-2.). Today, development practices such as groundwater pumping and construction drastically change the water table balances in the environment, thus altering water-drainage patterns. These practices can cause sinkhole collapses over time, and can even create larger cave formations (USGS. “Floridan Aquifer System.” USGS, fl.water.usgs. gov/floridan/visual_gallery.html).

Due to increased developmental practices in areas with karst landscape, the amount of sinkholes occurring in Florida, USA, has been both costly and hazardous to public health (Jones, Octavio. “Find Out What's Creating These Mysterious Holes.” National Geographic, National Geographic, 15 Sep. 2017, www.nationalgeographic.com/environment/sinkhole/). The overall cost of sinkhole damage has totaled $1.4 billion between 2006 and 2010 (Pearson, Michael. “A Loud Crash, Then Nothing: Sinkhole Swallows Florida Man.” CNN, Cable News Network, 5 Mar. 2013, www.cnn.com/2013/03/01/us/floridasinkhole/index.html). The media has oftentimes deemed sinkholes as a seemingly “random” event and because of the failures of current sinkhole detection techniques, many residents in areas underlain by limestone have been “swallowed” by sinkholes (Jones, Octavio. “Find Out What's Creating These Mysterious Holes.” National Geographic, National Geographic, 15 Sep. 2017, www.nationalgeographic.com/environment/sinkhole/). In July of 2017, a sinkhole approximately 225 feet in diameter and 50 feet deep swallowed two houses in Pasco County (Ellis, Ralph. “Sinkhole Swallows Homes in Florida.” CNN, Cable News Network, 15 Jul. 2017, www.cnn.com/2017/07/14/us/sinkhole-florida/index.html). Although property damage is an issue, the concern for residents' health is more urgent. In March of 2013, a sinkhole 30 feet deep swallowed and killed Jeff Bush while he was sleeping (Pearson, Michael. “A Loud Crash, Then Nothing: Sinkhole Swallows Florida Man.” CNN, Cable News Network, 5 Mar. 2013, www.cnn. com/2013/03/01/us/floridasinkhole/index.html).

Because of the prevalence of sinkholes in the United States today (in regards to increasing human activity and threats to public health), especially in regions underlain with karst landscape such as Florida, an effective sinkhole detection technique is needed. The current techniques for sinkhole detection include Interferometric Synthetic Aperture Radar (InSAR), Light Detection and Ranging (LIDAR), and Ground Penetrating Radar (GPR). LIDAR data analyzation transmits lasers to a target. The transmitted light is then reflected back to an instrument to be analyzed. InSAR varies with LIDAR by using multiple radar systems to calculate displacement, and it can therefore be applied to higher elevations through aerial transportation (University of Texas at San Antonio. “InSAR and LIDAR.” Lecture 9. 30 Oct. 2007, San Antonio, Texas). Both InSAR and LIDAR techniques measure surface displacement; this displacement is measured consistently over time to form a sinkhole map, as shown in FIG. 5 of Kobal's article (Kobal, Milan, et al. “Using Lidar Data To Analyse Sinkhole Characteristics Relevant For Understory Vegetation Under Forest Cover—Case Study Of A High Karst Area In The Dinaric Mountains.” Plos ONE 10.3 (2015): 1-19. Academic Search Premier. Web. 1 Dec. 2016). Although the sinkhole map has high accuracy and can calculate the width, length, area, depth, and concentration of sinkhole activity, the maps oftentimes take several months to develop and come at a high cost because of the consistent need for aerial transportation and high penetrating radars and lasers (Kobal, Milan, et al. “Using Lidar Data To Analyse Sinkhole Characteristics Relevant For Understory Vegetation Under Forest Cover—Case Study Of A High Karst Area In The Dinaric Mountains.” Plos ONE 10.3 (2015): 1-19. Academic Search Premier. Web. 1 Dec. 2016). Additionally, InSAR and LIDAR detection methods are handicapped by the strong dependence on particular features of sinkhole formation, such as decompaction of underground materials, water table changes, dense vegetation growth, and structural changes in underground units, making the techniques less applicable to different types and formations of karst landscape (Kobal, Milan, et al. “Using Lidar Data To Analyse Sinkhole Characteristics Relevant For Understory Vegetation Under Forest Cover—Case Study Of A High Karst Area In The Dinaric Mountains.” Plos ONE 10.3 (2015): 1-19. Academic Search Premier. Web. 1 Dec. 2016). More importantly, in terms of sinkhole detection, the methods can only be applied to cover subsidence sinkholes, where a sinkhole is visibly and topographically formed over time. However, the techniques are largely inapplicable to cover-collapse sinkholes, which are the most common and dangerous sinkhole type in the United States, because this sinkhole type does not provide topographical indications of underground sinkhole formation. Ground Penetrating Radar (GPR) is a technology that utilizes multi frequency electromagnetic surveys to visualize underground cavities (Anchuela, Óscar Pueyo, et al. “Integrated Approach for Sinkhole Evaluation and Evolution Prediction in the Central Ebro Basin (NE Spain).” International Journal of Speleology, vol. 46, no. 2, May 2017, p. 237. EBSCOhost, doi:10.5038/1827-806X.46.2.2064). The main drawback of GPR lies in its inability to detect cavities in conductive and heterogeneous conditions (i.e soils, clays, bedrocks, etc.) The geology of karst landscapes where sinkholes occur are highly heterogeneous and conductive, making GPR inapplicable.

In light of the aforementioned methods, there remains a need in the art to develop a system, method and device for real-time sinkhole detection that can monitor the process of sinkhole formation over a prolonged period of time, as opposed to independent, single frame detection, which only offers insight within a single frame of time.

### SUMMARY

Disclosed is a system for real-time sinkhole detection comprising a plurality of measuring devices, a network system, and an analysis system. The plurality of measuring devices include a plurality of sensors, wherein each of the plurality sensors is configured to: record a first type of spatial data and a second type of spatial data; process the first type and second type of spatial data by applying a first programmed filter to obtain a third type of spatial data; process the third type of spatial data by applying a second programmed filter to obtain a fourth type of spatial data; and compile the first, second, third and fourth type of spatial data into a data set. The network system is configured to electronically collect a plurality of the data sets from each of the plurality of sensors. The analysis system comprises an electronic database system and a server, wherein the server is configured to: electronically transmit the plurality of the data sets to the electronic database system; query the data set from the electronic database system; process the data set by applying a machine learning algorithm to generate a real-time result about sinkhole detection; transmitting the real-time result to an interface system; and update the electronic database system by transmitting the real-time result back to the electronic database system.

In addition to one or more of the features described above, the first type of spatial data comprises accelerometer data, and the second type of spatial data comprises gyroscope data.

In addition to one or more of the features described above, the third type of spatial data comprises attitude data.

In addition to one or more of the features described above, the fourth type of spatial data comprises quaternion data.

In addition to one or more of the features described above, each of the first programmed filter and the second programmed filter includes at least one of a Kalman filter and a Madgwick filter.

In addition to one or more of the features described above, the server is configured to electronically transmit the plurality of the data sets to the electronic database system using the internet.

In addition to one or more of the features described above, the electronic database system includes an online database system.

In addition to one or more of the features described above, the real-time result is transmitted to the interface system through the internet.

In addition to one or more of the features described above, the network system comprises a wireless sensor network system.

In addition to one or more of the features described above, the machine learning algorithm is selected from the group consisting of Artificial Neural Network, Naive Bayes Algorithm, K-Nearest Neighbor, Random Forest, and Support Vector Machines.

Disclosed is a measuring unit comprising a protective containment cap, a power supply section, and a metallic mesh section. The power supply section is positioned between the protective containment cap and the metallic mesh section, and the metallic mesh section comprises a microcontroller and a sensor.

In addition to one or more of the features described above, the metallic mesh section further comprises a waterproof container in which the microcontroller and the sensor are positioned.

In addition to one or more of the features described above, the metallic mesh section further comprises a power supply wire connecting the waterproof container to the power supply section.

In addition to one or more of the features described above, the metallic mesh section is filled with limestone.

Disclosed is a measuring device comprising plurality of measuring units as recited above. Each of the plurality of measuring units is connected by an attachment, which allows to collect spatial data from different subterranean locations.

Disclosed is a method of detecting a sinkhole comprising: obtaining a measuring device comprising a plurality of measuring units each comprising a protective containment cap, a power supply section, and a metallic mesh section, wherein the power supply section is positioned between the protective containment cap and the metallic mesh section, the metallic mesh section comprising a microcontroller and a sensor, wherein each of the plurality of measuring units is connected by an attachment configured to collect spatial data from different subterranean locations; positioning the measuring device at a subterranean location; collecting a plurality of data sets generated from the measuring device through a network system; electronically transmitting the plurality of data sets to an electronic database system; processing the plurality of data sets by applying a machine learning algorithm to generate a real-time result about sinkhole detection; transmitting the real-time result to an interface system; and updating the electronic database system by transmitting the real-time result back to the electronic database system.

In addition to one or more of the features described above, the plurality of data sets include accelerometer data, gyroscope data, attitude data, and quaternion data.

In addition to one or more of the features described above, the attitude data includes at least one of yaw, pitch and roll data.

In addition to one or more of the features described above, the machine learning algorithm is selected from the group consisting of Artificial Neural Network, Naive Bayes Algorithm, K-Nearest Neighbor, Random Forest, and Support Vector Machines.

### BRIEF DESCRIPTION OF THE DRAWINGS

The embodiments will become more fully understood from the detailed description and accompanying drawings, which are given for illustration only, and thus are not limitative of the present embodiment, and wherein:

FIG. 1 is a schematic diagram of a system for real-time sinkhole detection according to an exemplary embodiment of the invention.

FIG. 2 is a diagram showing the data transmission process in the network system.

FIG. 3 shows the detailed structure of the machine learning system.

FIG. 4 shows an exemplary embodiment of a sensor pole.

FIG. 5 shows an exemplary embodiment of a metallic mesh section of a measuring unit.

FIG. 6 is a diagram showing a physical model to simulate cover collapse sinkholes.

FIG. 7 shows a cover collapse sinkhole simulation with the development of a self-supporting arch as a cavity forms underground. The clay ridges forming at the surface aid in the formation of the arch.

FIG. 8 shows a cover collapse sinkhole simulation with large sinkhole formation in the center of the model.

FIG. 9 shows a cover collapse sinkhole simulation with large sinkhole formation on the right side of the model.

FIG. 10 shows release port outputs from the water tables flowing through the sinkhole model.

FIG. 11 is table showing testing accuracy by applying the Neural Network Algorithm.

FIG. 12 is table showing testing accuracy by applying the Naive Bayes Algorithm.

FIG. 13 is table showing testing accuracy by applying the K-Nearest Neighbor Algorithm.

FIG. 14 is table showing testing accuracy by applying the Random Forest Algorithm.

FIG. 15 is table showing testing accuracy by applying the Support Vector Machines (SVM) Algorithm.

FIG. 16 shows a Pugh matrix displaying the effectiveness of the sensing device methodology.

FIG. 17 is table showing testing accuracy by applying the Neural Network Algorithm with trilateration localization methodology.

FIG. 18-19 show the application of the trilateration algorithm to location prediction of future sinkholes in real-time.

FIG. 20 is table showing testing accuracy by applying the Random Forest Algorithm with trilateration localization methodology.

FIG. 21 shows a sample acceleration data prior to Machine Learning Algorithm computation.

### DETAILED DESCRIPTION

A detailed description of one or more embodiments of the disclosed apparatus and method are presented herein by way of exemplification and not limitation with reference to the Figures.

The major objective of sinkhole detection is to provide consistent monitoring of underground water tables at an efficient rate while considering cost and time, and maintaining the accuracy of detection data. This same objective is shared by the Civil Engineering field through the Structural Health Monitoring System (SHMS). SHMS utilizes clusters of sensors and places the sensors throughout a man-made structure (i.e building, bridge, etc.). The sensors can detect areas of stress and strain within the structure in real-time because of the system's advanced integration of sensors, data transmission, computational power, and processing ability (Balageas, Daniel, et al. Structural Health Monitoring. ISTE, 2006). SHMS is a highly applicable system; it has been applied to Reactor Containment Buildings to reduce potential nuclear catastrophes (Jianguo, Zhou, et al. “A Wireless Monitoring System for Cracks on the Surface of Reactor Containment Buildings.” Sensors (14248220), vol. 16, no. 6, June 2016, p. 1. EBSCOhost, doi:10.3390/s16060883) as well as to aircrafts to predict and monitor damage (Krishnaswamy, Sridhar. “Structural Health Monitoring for Life Management of Aircraft.” SHM System for Composite Structures. The Joint Advanced Materials and Structures Center of Excellence).

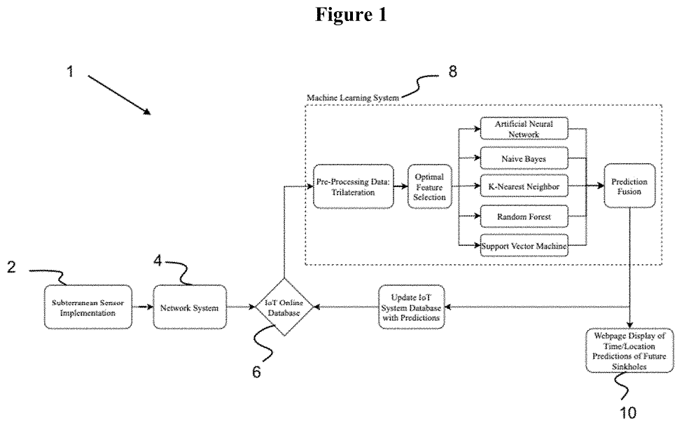

The Wireless Sensor Network (WSN) is a communication system between sensors and is commonly applied to SHMS. WSN can be used in monitoring and controlling parameters in field locations where sensor networks may be implemented (Jaladi, Aarti Rao, et al. “Environmental Monitoring Using Wireless Sensor Networks (WSN) Based on TOT.” International Research Journal of Engineering and Technology (IRJET), vol. 4, no. 1, January 2017, pp. 1371-1378., www.irjet.net/archivesN4/il/IRJET-V4I1246.pdf). WSN allows data to be viewed in real time via wireless connection or access to a database cloud. The network is oftentimes applied to environmental monitoring systems, such as earthquake detection systems, since the efficient communication between the sensor network and the accessible database allows for risk mitigation during disastrous events (Michelini, Alberto, et al. “The Italian National Seismic Network and the Earthquake and Tsunami Monitoring and Surveillance Systems.” Advances in Geosciences, vol. 43, September 2016, pp. 31-38., doi:10.5194/adgeo-43-31-2016). The Italian National Seismic Network, consisting of over 400 stations throughout Italy with GPS receivers, seismic sensors and accelerometers, communicates all data to a base station in Rome via WSN and SHMS. At this base station, the process of data analysis is initiated and earthquake and tsunami warnings are either triggered or removed. The accuracy of the data provided by SHMS paired with the real-time data analysis allows for a “shake” map, which can detect an earthquake's epicenter, to be created within minutes, as shown in FIG. 1 of Michelini's publication (Michelini, Alberto, et al. “The Italian National Seismic Network and the Earthquake and Tsunami Monitoring and Surveillance Systems.” Advances in Geosciences, vol. 43, September 2016, pp. 31-38., doi:10.5194/adgeo-43-31-2016). The effectiveness of WSN and SHMS within Italy's National Seismic Network support its applicability to other environmental detection systems, such as sinkhole detection systems.

In conjunction with WSN, the Internet of Things (IoT) is oftentimes applied to create a user-friendly interface. IoT is the network of devices connected to the Internet and transmitting data. The integration of IoT with a sensor network allows for widespread connectivity and data security; data can be stored in real-time to a database cloud, which can then be accessed by users without compromising the accuracy or efficiency of data transmission (Atzori, Luigi, et al. “The Internet of Things: A Survey.” Computer Networks, vol. 54, no. 15, 2010, pp. 2787-2805, doi:10.1016/j.comnet.2010.05.010). Furthermore, the application of the IoT can allow for a consolidation between the SHMS and WSN application through an easy to access, user-friendly interface that displays the most prevalent data to users (Yu, Wei, et al. “A Survey on the Edge Computing for the Internet of Things.” IEEE Access, vol. 6, 2018, pp. 6900-6919., doi:10.1109/access.2017.2778504). This data is oftentimes processed prior to display, and thus, IoT serves a large data analysis function within the overall sensor network architecture.

To ensure the accuracy of the real-time data processing of sensor data from the network, Artificial Intelligence can be applied through Machine Learning (ML) Algorithms. ML Algorithms extract and process information from large sets of data for classification and feature functions (Ghaoui, Laurent El, et al. “Understanding Large Text Corpora via Sparse Machine Learning.” Statistical Analysis and Data Mining, vol. 6, no. 3, 2013, pp. 221-242., doi:10.1002/sam.11187). A major concern within the development of a sinkhole detection network is that external factors may disrupt or cause false positives in detection of sinkhole formation. These external factors include pumping systems that may provide movement signals to sensors. This potential source of error is maximized when data analysis is conducted manually. The application of Machine Learning can eliminate the threat of false positives as the large data processing capabilities of this AI technique can incorporate safeguards to properties that may falsely indicate sinkhole formation. Thus, data analysis is automated as opposed to manually completed.

The objective of this project is to engineer a real-time method to detect sinkholes prior to collapse. The methodology behind this project is to implement a subterranean sensor network that can detect the underground changes that contribute to sinkhole development. By applying technologies from the civil engineering and computer science field, a novel interdisciplinary sinkhole detection method can be created. It is hypothesized that the system created through the application of civil engineering techniques, the Internet of Things (IoT), and Artificial Intelligence will allow for the creation of a more successful sinkhole detection system compared to current techniques based on criteria of accuracy, efficiency, ease of implementation, cost, and real-time detection.

The Engineering and Design Process incorporated in the development of this sinkhole detection method is described through three subsections: the design and development of the sensor network, engineering the sensing device, and creating the physical model to simulate cover collapse sinkholes.

### The Design and Development of the Sensor Network

Cover collapse sinkholes are created from dissolution of limestone and bedrock layers by water tables, and thus, if excessive water movement and dissolution is recorded, a sinkhole can potentially be predicted prior to collapse and can be monitored or filled by structural health officials. In order to record water movement, the acceleration of sensors as well as the position of sensors are important as measures for changes in subterranean activity. An accelerometer is a sensor type that can provide these values through a gyroscope breakout board. The most common type of accelerometer is the MPU6050 accelerometer since it contains an embedded GY-521 6-axis breakout board. The sensor type was chosen for its open source codes and adaptability to open source hardware.

The sensors were first calibrated and the offsets were incorporated into the program. Then, the data sets were programmed. The data sets programmed included the raw accelerometer data, raw gyroscope data, Yaw Pitch Roll (YPR) angles, and Quaternion data. YPR has a center of gravity and rotation (Smithsonian National Air and Space Museum. “Roll, Pitch, and Yaw.” How Things Fly, howthingsfly.si.edu/flight-dynamics/roll-pitch-and-yaw), which provides the optimal measure for orientation. The orientation provided by YPR Angles is significant as it can provide vast ranges of data for underground water movement relative to initial position, and thus, helps to maintain the accuracy of the dataset. The YPR angles and Quaternions were calculated through programmed filters that utilized applied mathematics and physics. Quaternions were utilized because YPR angles are susceptible to Gimbal Lock. Gimbal Lock is a phenomenon that creates parallel degrees of freedom within angular data and affects sensor data accuracy (Kou, Kit Ian, and Yong-Hui Xia. “Linear Quaternion Differential Equations: Basic Theory and Fundamental Results.” Studies in Applied Mathematics, vol. 141, no. 1, 2018, pp. 3-45., doi:10.1111/sapm.12211). By applying the complex plane through Quaternion calculations, Gimbal Lock occurrences can be mathematically detected. The raw accelerometer and raw gyroscope data were passed through a programmed mathematical filter to output the YPR Angles and Quaternions. YPR angles were determined through a complementary high and low pass filter which integrated the gyroscope data and derived the accelerometer data. This filter provided a YPR value for each axes of the angle. The architecture of the complementary filter is shown as follows.

The Quaternion data was converted from the YPR angle data through the application of linear algebra and rotational matrices. Quaternions have four axes because the data incorporates the complex plane. The mathematical conversion is shown as follows.

$$q = [ \begin{matrix}cos ( \frac{ψ}{2} ) \\ 0 \\ 0 \\ sin ( \frac{ψ}{2} )\end{matrix} ] [ \begin{matrix}cos ( \frac{θ}{2} ) \\ 0 \\ sin ( \frac{θ}{2} ) \\ 0\end{matrix} ] [ \begin{matrix}cos ( \frac{φ}{2} ) \\ sin ( \frac{φ}{2} ) \\ 0 \\ 0\end{matrix} ] = ( \begin{matrix}cos ( \frac{φ}{2} ) cos ( \frac{θ}{2} ) cos ( \frac{ψ}{2} ) + sin ( \frac{φ}{2} ) sin ( \frac{θ}{2} ) sin ( \frac{ψ}{2} ) \\ sin ( \frac{φ}{2} ) cos ( \frac{θ}{2} ) cos ( \frac{ψ}{2} ) - cos ( \frac{φ}{2} ) sin ( \frac{θ}{2} ) sin ( \frac{ψ}{2} ) \\ cos ( \frac{φ}{2} ) sin ( \frac{θ}{2} ) cos ( \frac{ψ}{2} ) + sin ( \frac{φ}{2} ) cos ( \frac{θ}{2} ) sin ( \frac{ψ}{2} ) \\ cos ( \frac{φ}{2} ) cos ( \frac{θ}{2} ) sin ( \frac{ψ}{2} ) - sin ( \frac{φ}{2} ) sin ( \frac{θ}{2} ) cos ( \frac{ψ}{2} )\end{matrix} )$$

These conversions were incorporated into the overall programming of each sensor. Through this incorporation, the raw accelerometer and gyroscope data was converted in real-time.

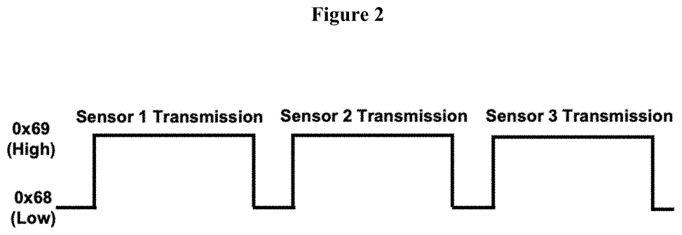

Within the network, multiple sensors are connected to a single microcontroller. This practice is heavily favored since this can greatly reduce communication transfer overload/“traffic” and is much more cost effective than assigning one microcontroller to each sensor. The sensor network was developed to connect all sensors to a single I2Ccommunication line and microcontroller. This was achieved by utilizing the two bus lines of the MPU 6050 sensor. The two addresses are for registers 0x68 and 0x69 (ADO low and high, respectively). The 0x69 line was pulled low while the 0x68 was communicating data through the line and the sensor data was communicated through a code iteration. This process is shown in FIG. 2.

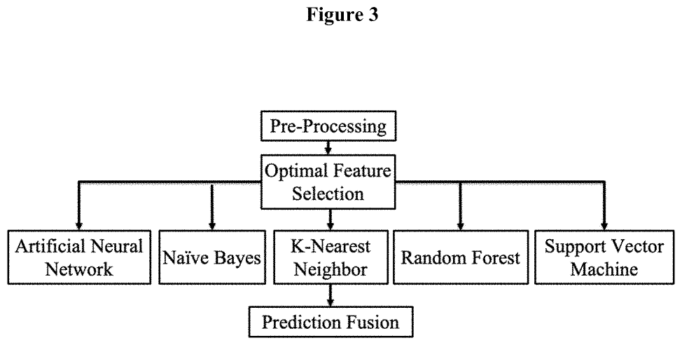

The Machine Learning Algorithm architecture included preprocessing, optimal feature, and classifier layers. A classifier was first run through the raw data, in which sensor data from a single location was compiled into a CSV file. Then, various ML algorithms were run with this data. The data was split with 60% training, 20% validation, and 20% testing. The ML algorithms computed were the Artificial Neural Network, Naive Bayes Algorithm, K-Nearest Neighbor, Random Forest, and Support Vector Machines (SVM). These are supervised ML algorithms. After this process was completed, the machine learning algorithms could compute predictions for sinkhole detection occurrences based on real-time sensor data outputs. Thus, data analysis is computed in real-time. The ML algorithms allowed for complete system automation of the sensor network. The overall architecture of the ML is shown in FIG. 3.

The application of the Internet of Things (IoT) used a wireless architecture. The architecture involved the programming of a PHP server to transmit the data from the sensor network in real-time to a MySQL online database. The My SQL database then requested PHP queries and used and transmitted the last recorded data entry/output to a webpage. The webpage was a user-friendly interface that was programmed to display the last outputted data set. The entirety of the data set can be accessed with MySQL, which is wirelessly connected to the sensor network through this architecture.

### Engineering the Sensing Device

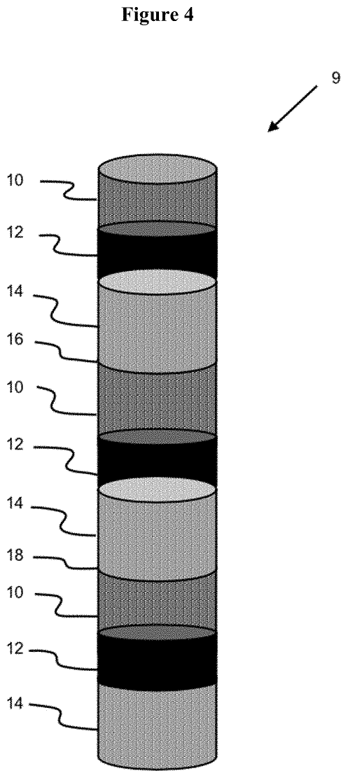

To prototype this system, a sensor pole was created in which the accelerometer was embedded into the device. A sensor pole structure was the optimal device for implementing the sensor network because the layering effect allowed for a three dimensional analysis of the subterranean profile based on depth and planar location. The structure specifies the location when there is subterranean activity, making the ease of action highly favorable and applicable. The sensor pole was created through sections of repeatable structure; each section had a protective containment cap, a power supply, and a metallic mesh. This design is shown in FIG. 4.

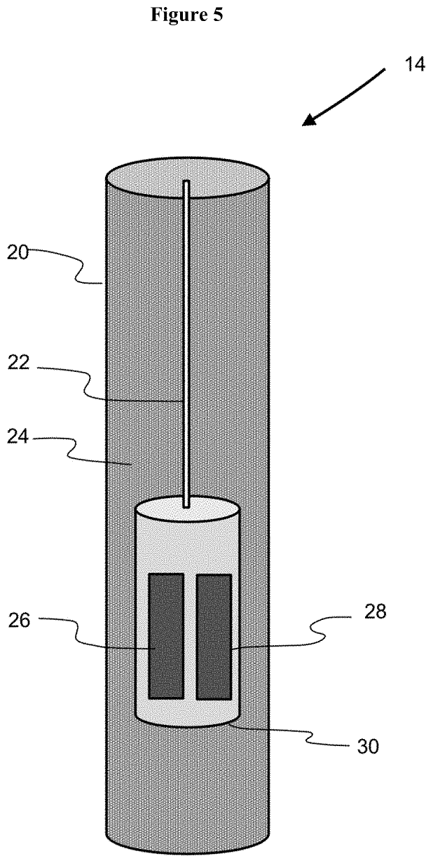

The metallic mesh section contained the microcontroller and sensor components. The metallic mesh portion of the sensing device is shown in FIG. 5. The microcontroller and sensor were placed into a waterproof container and the power supply was wired outwards into a containment subsection. The tension of the power supply was held with a solid limestone piece. The chemical component was introduced through the application of limestone, which dissolves under acidic conditions (calcium carbonate, the principal component of limestone, is slightly soluble in acidic solutions). The concept behind this prototype is that as groundwater and acidic rain erodes and dissolves the limestone tracts that underlay karst landscape, the limestone within the sensor pole will also dissolve. The mesh acts as a semipermeable membrane and allows for the acidic solution to pass through, but prevents larger rocks (that may have been the product of gradual erosion) from damaging the device. The pole was designed such that the limestone could be supplemented if needed through the ground level. The accelerometer is embedded within the limestone piece and when the limestone is dissolved, the accelerometer will be free to oscillate within the fixed netted area. The accelerometer moves and detects changes within the sensor outputs as a direct result from the empty cavity space that now allows for water tables to freely flow through. When a large cavity has formed, the sensor data will have changed significantly through all the sensors within the sensor network (derived from depth component of sensor pole). Through this design, there are essentially two sensors at play; one is chemical (limestone) and the other is programmed (accelerometer).

The process of limestone dissolution can be described through the following reactions:

CACO₃+H₂O+CO₂→Ca(HCO₃)₂

H₂O+CO₂→H₂CO₃

CaCO₃+H₂CO₃→Ca(HCO₃)₂(soluble)

Carbonic Acid (H2CO3) is the primary agent during limestone dissolution. Limestone is a sedimentary rock with high Calcium Carbonate (CaCO3) content. Hydrogen ions give natural rain water a slightly acidic pH value. In regions with high industry and pollution, rain water becomes overly acidic. This overcomes the buffering capacity of groundwater and changes the equilibrium of the groundwater system (Hanshaw BB, Back W, and Rubin M. “Carbonate equilibria and radiocarbon distribution related to groundwater flow in the Floridan Limestone aquifer, USA.” Proceedings of International Association on Science of Hydrology, Dubrovnik, 1965, pp 601-614). Once this equilibrium is disrupted, the limestone dissolution process becomes a continuous cyclic pattern and is expansive. When cavities form in a karst landscape, this property guarantees the existence of additional dissolved limestone (Hanshaw B B, Back W, and Rubin M. “Carbonate equilibria and radiocarbon distribution related to groundwater flow in the Floridan Limestone aquifer, USA.” Proceedings of International Association on Science of Hydrology, Dubrovnik, 1965, pp 601-614). The cyclic nature of limestone dissolution contributes to the dangerous capacity for cover-collapse sinkholes to form in karst. This process is capitalized in the sensor device design; the device is engineered to model the limestone dissolution process and thus, the density of sensor devices implemented can be very low and cost effective.

### Developing a Localization Methodology

Using a True Range Multilateration (Trilateration) Methodology, a localization algorithm for sinkhole detection was derived. Since three sensing devices were implemented during experimentation, a trilateration methodology was used. To determine the radii of sensors, the point of convergence was determined by Equation 1.

The trilateration methodology ensured that as sensing device radii intersected, the convergence point or overlapped area would indicate a predicted sinkhole location. The algorithms used to compute sinkhole area are shown in Equation 2.

The application of a trilateration localization methodology was used to aid in real-time location prediction accuracy alongside the Machine Learning Algorithms.

FIG. 1 is a schematic diagram of a system for real-time sinkhole detection according to an exemplary embodiment of the invention. The system 1 for real-time sinkhole detection 1 includes a subterranean sensor implementation system 2, a network system 4, an IoT online Database 6, a machine learning system 8, and a user-friendly display system 10.

The subterranean sensor implementation system 2 comprises a plurality of measuring devices, in which a plurality of sensors are embodied to detect the movement of subterranean water and measure limestone dissolution. The raw data collected from sensors is programmed and generate a plurality of data sets, wherein each data set includes raw accelerometer data, raw gyroscope data, Yaw Pitch Roll (YPR) angles, and Quaternion data.

The programmed data sets then are transferred to the network system 4 through the process shown in FIG. 2. The IoT techniques applied in the system is using a wireless architecture, which means a programmed PHP server is used in the system to process and transfer data from the network system 4 to the IoT online Database 6 in real time. The data sets then are stored in the IoT online database 6. The machine learning system 8 is run on the programmed PHP server.

The machine learning system 8 includes a preprocessing section, an optimal feature section, five machine learning algorithms, and a prediction fusion section. Before the five machine learning algorithms are capable to compute predictions for sinkhole detection occurrences in real time, they should be trained by a plurality of data sets. The training process works as follows. First, a plurality of data sets are queried from the IoT Online Database 6. Second, the data sets are split with 60% training, 20% validation, and 20% testing. Third, the five machine learning algorithms are run with the data sets. After the process is completed, the machine learning algorithms could compute predictions for sinkhole detection occurrences based on real-time sensor data outputs. When the system works, a classifier is first run through the data sets, in which the data sets from a single location is compiled into a CSV file. Then, five computed machine learning algorithms are run with the data and generate prediction results. The prediction results are transferred to the user-friendly display system 10, which comprises a webpage that is programmed to display the predicted time and location of future sinkholes. In addition, the prediction results are transferred back to the IoT Online Database 6 to further update the database.

FIG. 2 is a diagram showing the data transmission process in the network system. Within the network system 4, multiple sensors are connected to a single microcontroller. This practice is heavily favored since this can greatly reduce communication transfer overload/“traffic” and is much more cost effective than assigning one microcontroller to each sensor. The sensor network was developed to connect all sensors to a single I2Ccommunication line and microcontroller. This was achieved by utilizing the two bus lines of the MPU 6050 sensor. The two addresses are for registers 0x68 and 0x69 (ADO low and high, respectively). The 0x69 line was pulled low while the 0x68 was communicating data through the line and the sensor data was communicated through a code iteration.

FIG. 3 shows the detailed structure of the machine learning system. The machine learning system 8 includes a preprocessing section, an optimal feature section, five machine learning algorithms, and a prediction fusion section. The five machine learning algorithms include the Artificial Neural Network, Naive Bayes Algorithm, K-Nearest Neighbor, Random Forest, and Support Vector Machines (SVM).

FIG. 4 shows an exemplary embodiment of a sensor pole 9, which comprises a plurality of measuring units. Each measuring unit includes a protective cap 10, power supply section 12, metallic mesh section 14. The power supply section is positioned between the protective containment cap 10 and the metallic mesh section 14. Separate measuring units are connected through the attachments 16 and 18, and assembled into a sensor pole.

FIG. 5 shows an exemplary embodiment of a metallic mesh section 14 of a measuring unit. A metallic mesh section comprises a microcontroller 26 and a sensor 28, which are placed into a waterproof container 30. A power supply 22 is wired from waterproof container 30 outwards into a containment subsection 24. The containment subsection is filled with limestone. The tension of the power supply 22 is held with the limestone. The chemical component is introduced through the application of limestone, which dissolves under acidic conditions (calcium carbonate, the principal component of limestone, is slightly soluble in acidic solutions). The concept behind this prototype is that as groundwater and acidic rain erodes and dissolves the limestone tracts that underlay karst landscape, the limestone within the sensor pole will also dissolve. The metallic mesh 20 acts as a semipermeable membrane and allows for the acidic solution to pass through, but prevents larger rocks (that may have been the product of gradual erosion) from damaging the device. The pole was designed such that the limestone could be supplemented if needed through the ground level. The sensor 28 is embedded within the limestone and when the limestone is dissolved, the sensor 28 will be free to oscillate within the fixed netted area. The sensor 28 moves and detects changes within the sensor outputs as a direct result from the empty cavity space that now allows for water tables to freely flow through. When a large cavity has formed, the sensor data will have changed significantly through all the sensors within the sensor network (derived from depth component of sensor pole). Through this design, there are essentially two sensors at play; one is chemical (limestone) and the other is programmed (accelerometer).

### EXAMPLE 1—A PHYSICAL MODEL TO SIMULATE COVER COLLAPSE SINKHOLES

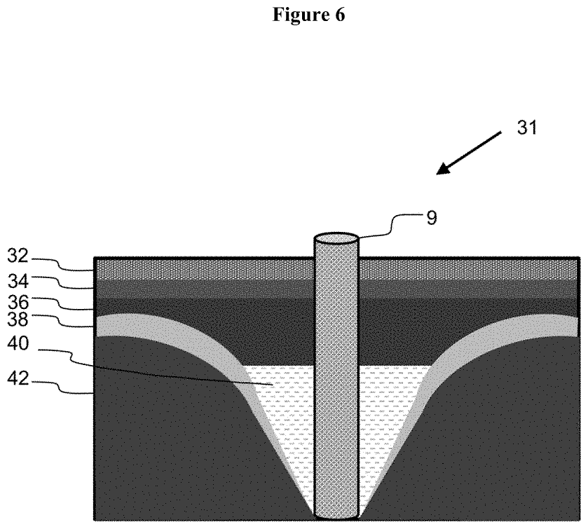

A sinkhole was physically modeled to test the sensing device. The sinkhole model was created with materials typical for a sinkhole in Florida (cover collapse sinkhole type). A major part of the sinkhole formation process is the formation of a self-supporting roof with silt, clay, sandstone, gravel, limestone, and bedrock. When the arch of this formation loses strength, the sinkhole will collapse (Currens, James. “Cover-Collapse Sinkholes in Kentucky, USA: Geographic and Temporal Distribution.” Carbonates & Evaporites, vol. 27, no. 2, June 2012, p. 137. EBSCOhost, doi:10.1007/s13146-012-0097-2). In order to replicate this sinkhole, materials of limestone, marble chips, sand, clay, and soil were utilized in the experiment. The limestone was concentrated in large tracts underground, as opposed to layered structures of limestone (modelling Central Florida geology). The surface of the sinkhole was maintained through the duration of the sinkhole formation process from the use of soil, clay, and marble chips in the upper layers of the simulation set-up. This allowed for the creation of a self-supporting arc. A gradual water force, which was introduced and piped through rubber tubing, was used to simulate water tables. Sand was also utilized within the simulation because the Florida groundwater system contains large amounts of sand to trap surface water. The varying compositions/materials had different mesh profiles. The mesh profiles allowed for geophysics to be extensively considered during the development of the simulation. A dam was also built to allow for the water tables to flow through instead of rise and flood the model. This dam consisted of an arc and a circular drilled hole for drainage. The overall design of the physical model is shown in FIG. 6.

A total of 36 trials and simulations were run. The aforementioned model was rebuilt for each trial. The overall scale of the model was a 1.5 by 0.75 meter base with a 1 meter height.

FIG. 6 depicts a cover collapse sinkhole model 31, which is composed of granite 42, limestone 40, sand 38, soil 36, clay 34, and marble chips 32. During each simulation, a total of three sensing devices 9 were deployed.

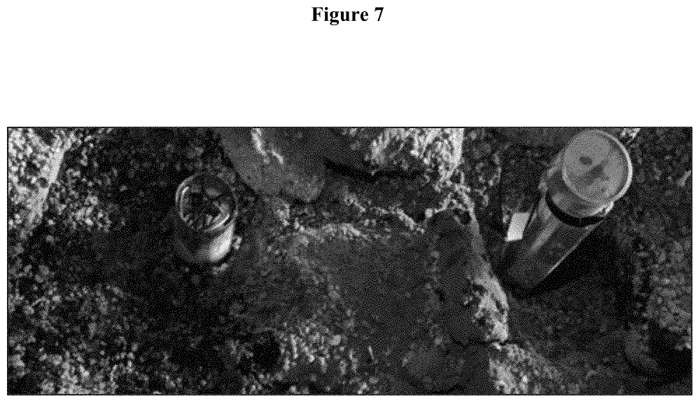

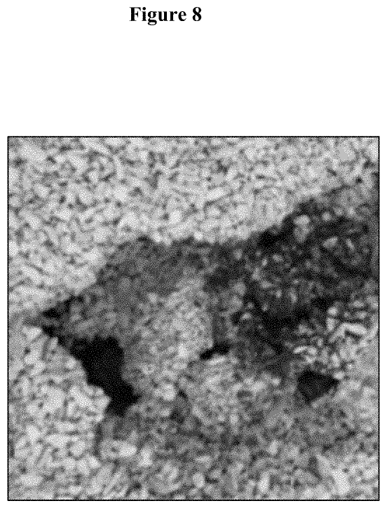

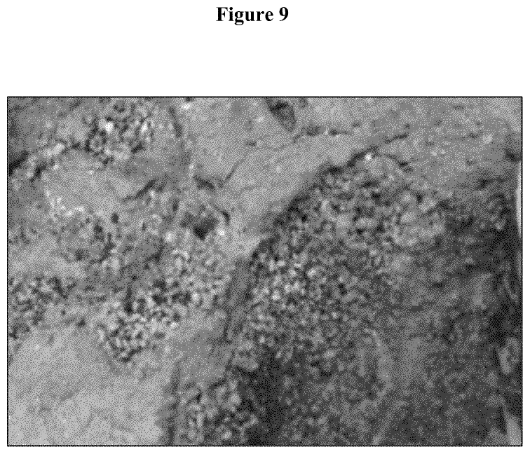

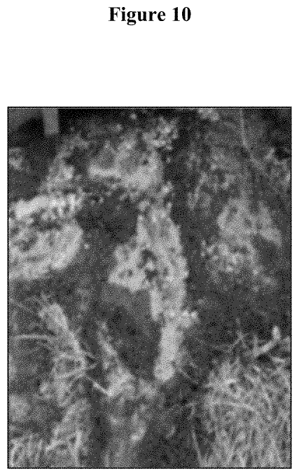

The resulting sinkhole formations and dam output are shown in FIGS. 7-10. The sinkhole simulations successfully maintained a cover for the duration of the sinkhole formation process until collapse.

### EXAMPLE 2—APPLYING MACHINE LEARNING ALGORITHMS TO PREDICT SINKHOLE OCCURRENCE IN REAL TIME

The application of Machine Learning (ML) involved the algorithms of Artificial Neural Networks, Naive Bayes, K-Nearest Neighbor, Random Forest, and Support Vector Machines (SVM). These algorithms were trained, validated, and tested for the final accuracy.

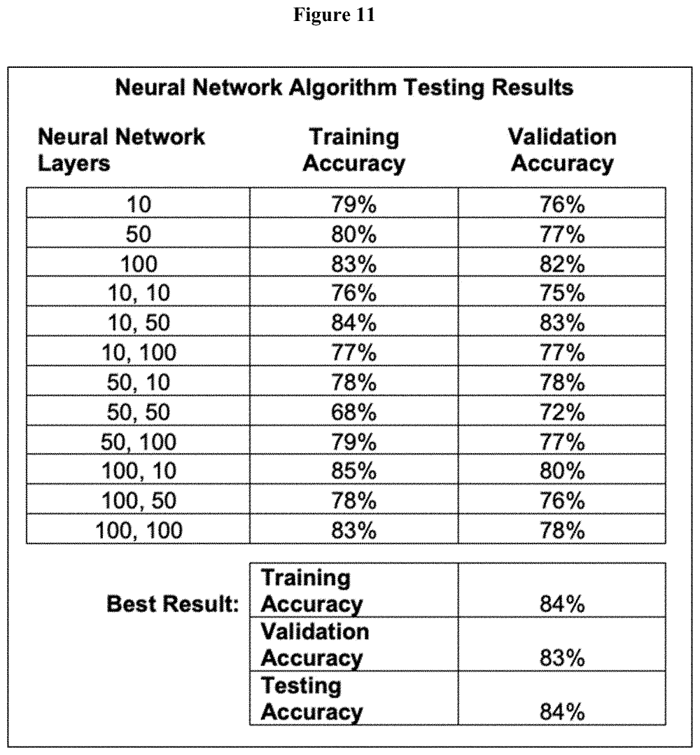

For the Neural Network, various layer and neuron combinations were tested, and the most accurate combination was [10, 50] in which the algorithm achieved 84% testing accuracy, as shown in FIG. 11.

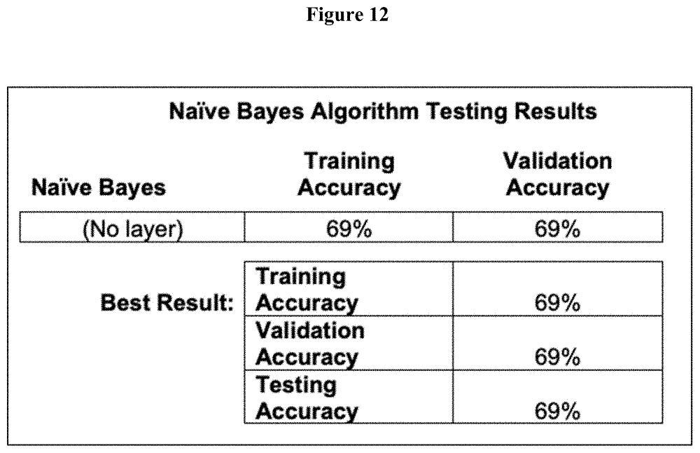

For the Naive Bayes algorithm, the algorithm achieved 69% testing accuracy, as shown in FIG. 12 (This Machine Learning Algorithm does not utilize layers).

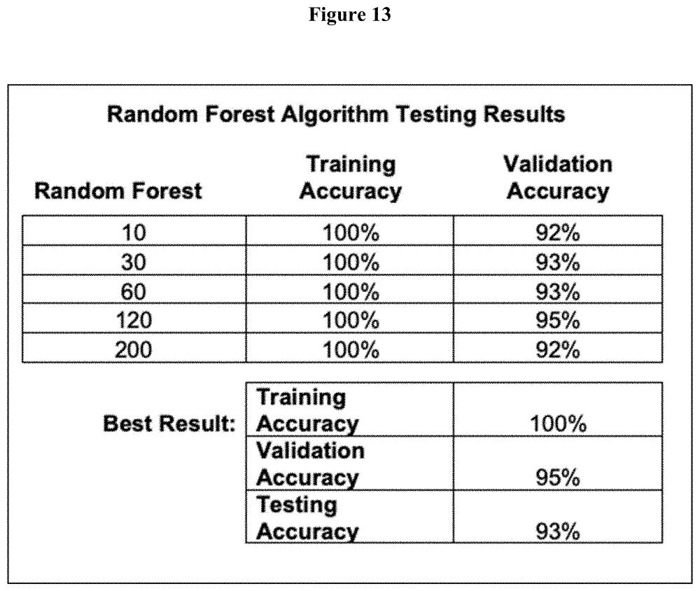

The K-Nearest Neighbor Algorithm (KNN) had a testing accuracy of 91%. The lowest testing accuracy that the KNN algorithm had was 83% at 31 K-nearest neighbors, as shown in FIG. 13.

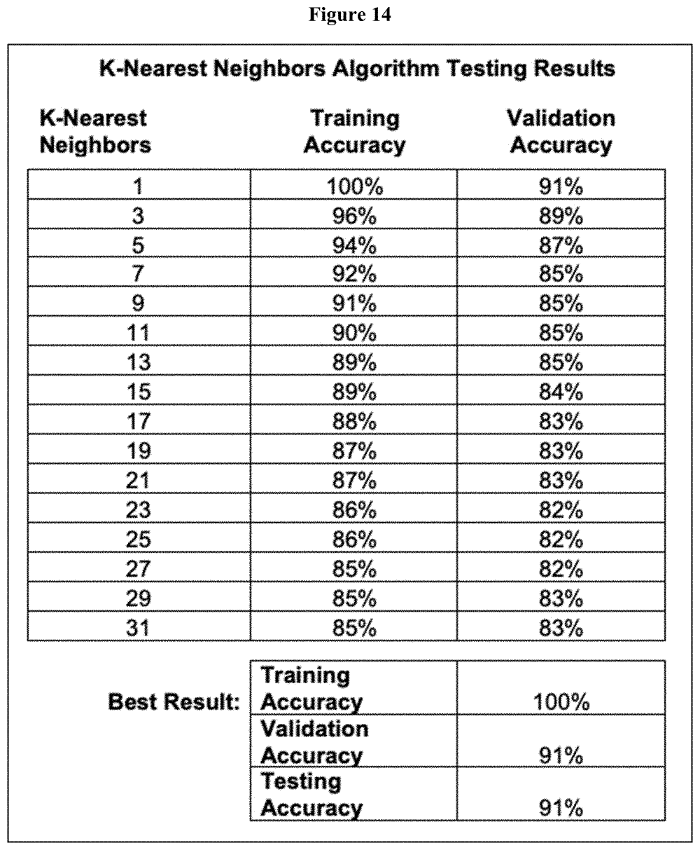

For the Random Forest Algorithm, there was the highest testing accuracy out of the various ML algorithms programmed. The Random Forest algorithm obtained an optimal testing accuracy of 93% when there were 120 random forests. The lowest accuracy obtained was 92% at 10 and 200 trees, as shown from FIG. 14.

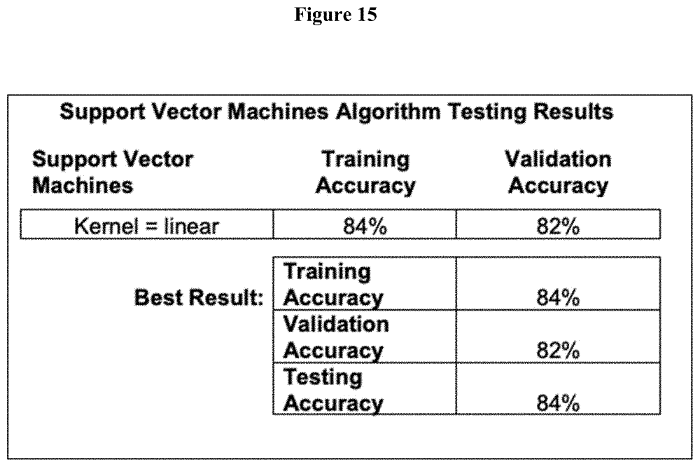

For the Support Vector Machines (SVM) Algorithm, there was an optimized testing accuracy of 84%. This is shown in FIG. 15.

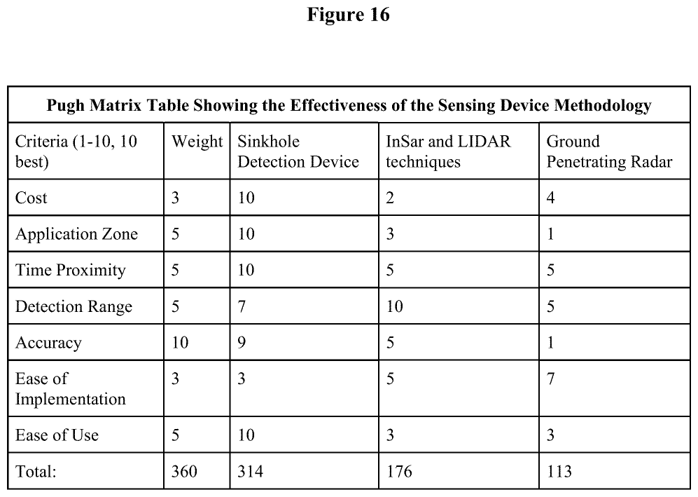

A Pugh matrix displaying the effectiveness of the sensing device methodology is shown in FIG. 16.

The Pugh matrix has criteria of cost, application zone, time proximity, detection range, accuracy, ease of implementation, and ease of use. The cost of the sinkhole detection device is $150 per device, while InSAR and LIDAR techniques range from $10,000 to $20,000 per year for 3 meter to 5 meter resolution (PTAC Petroleum Technology Alliance Canada. “Study of Low Cost InSAR for SAGD Steam Chamber Monitoring.” Look North Report, 2015, www.ptac.org/wp-content/uploads/2016/08/Final-Report-16. pdf). Furthermore, Ground Penetrating Radar techniques average at a cost of $14,000 (US Radar. “Ground Penetrating Radar Cost.” US Radar, US Radar Inc. Subsurface Imaging Systems, 3 Nov. 2016, www.usradar.com/ground-penetrating-radar-cost/). The application zone (sinkhole type) for the device is cover collapse, cover subsidence, and solution sinkholes. For InSAR and LIDAR techniques, the application zone is limited to subsidence sinkholes, while GPR can only be applied for sinkholes/voids in homogenous and nonconductive compositions. The time proximity of the device includes real-time detection, while InSAR/Lidar and GPR technologies are single frame detections. The detection range of the device is estimated to be one device per square mile, as compared to the range of up to 2,000 square kilometers from InSar/LIDAR and a 5-10 foot depth range of GPR. The device has an optimized accuracy of 93%, while InSAR/LIDAR is accurate only in subsidence sinkholes and GPR accuracy is limited to non-conductive landscape applications. To initialize the device, in one non-limiting embodiment the sensing device can be implemented 10 meters underground. InSAR/LIDAR and GPR are non-invasive techniques, however, extensive preliminary modelling is needed prior to implementation. For ease of use, the device is wirelessly connected such that once initialized, the sensing device can detect without manual requirements. InSAR/LIDAR requires consistent use of radar systems and GPR requires consistent movement along the applied landscape.

### EXAMPLE 3—APPLYING MACHINE LEARNING ALGORITHM INTEGRATED WITH TRILATERATION LOCALIZATION METHOD TO PREDICT SINKHOLE OCCURRENCE IN REAL TIME

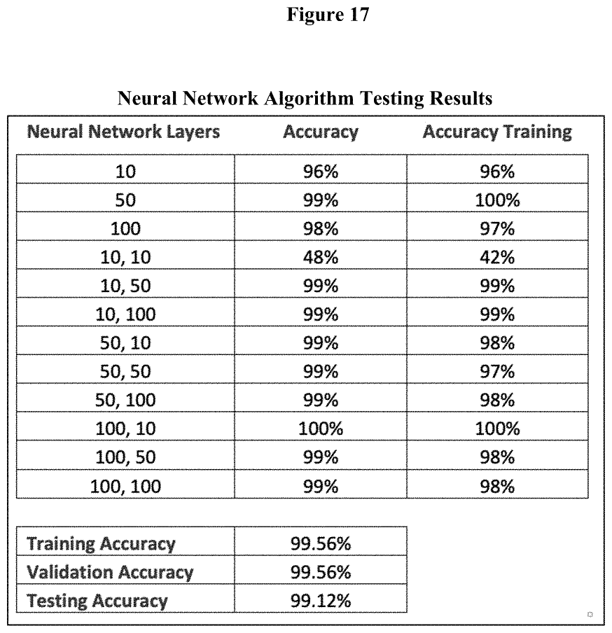

The Neural Network achieved the highest localization prediction accuracy for sinkholes, with a testing accuracy of 99.12%, as shown in FIG. 17.

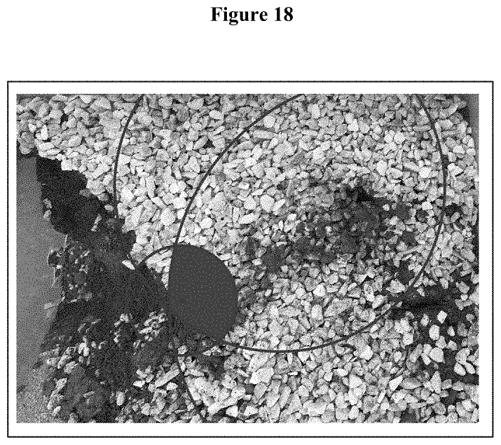

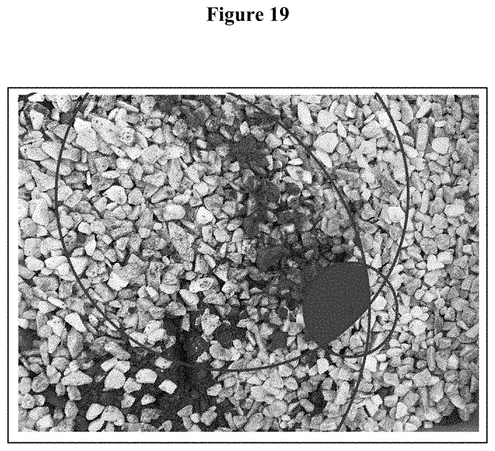

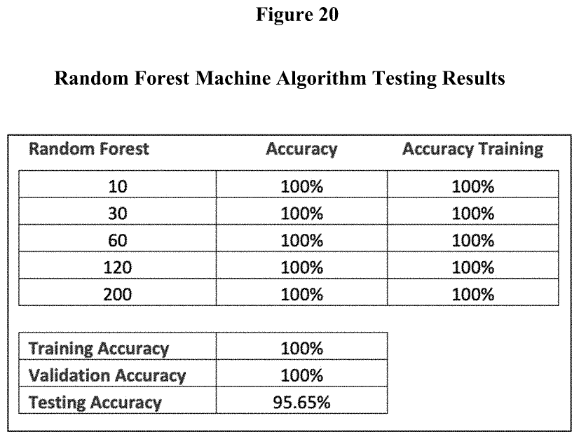

The Trilateration Localization methodology was used alongside the Machine Learning Algorithm as a feature to further optimize prediction accuracy. The trilateration methodology, shown in FIGS. 18 and 19, was able to detect both the source and location of future sinkhole occurrences prior to collapse.

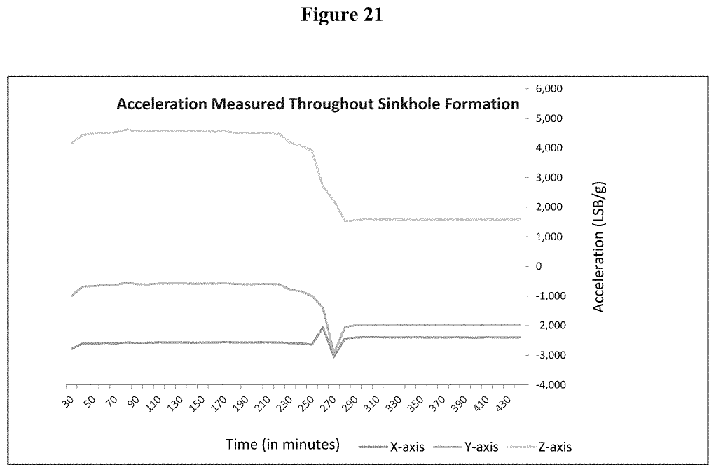

The Random Forest Machine Learning Algorithm achieved the highest time prediction accuracy for sinkholes, with a testing accuracy of 95.65%, as shown in FIG. 21.

The data analysis and predictions were completed through Machine Learning Algorithms which processed the real-time sensor network data (acceleration, gyroscopic orientation, YPR angles, and Quaternion data). A sample of this data prior to Machine Learning Algorithm computation can be found in FIG. 22.

A novel, interdisciplinary sinkhole detection system derived from civil engineering techniques, the Internet of Things (IoT), and Artificial Intelligence more effectively detected underground cavities and sinkholes in karst landscape as compared to current methods. By engineering a subterranean sensor network, the sensing device was able to diagnose underground structural health changes in karst which contributed to sinkhole formation in the future. Furthermore, through an application of the Wireless Sensor Network, the Structural Health Monitoring System, and the Internet of Things, a user-friendly interface that had real-time capabilities was created.

The high accuracy of the supervised Machine Learning Algorithm indicates that the sensing device is effective in implementation. The Neural Network Machine Learning Algorithm achieved a 99% localization accuracy and the Random Forest Algorithm achieved a 95% time prediction accuracy. The high accuracy of the Machine Learning Algorithms provided for an effective real-time prediction model for impending sinkhole/cavity development prior to the collapse of the void.

By modeling the limestone dissolution process that causes sinkholes, the sensor network and sensing device was able to directly measure the rate of dissolution through the real-time Machine Learning prediction system. Since the limestone dissolution process is expansive and cyclic in nature, the implementation density for the sensing device is low and cost effective. This methodology provides detection with 99% and 95% accuracy respectively for location and time prediction of future sinkhole occurrences at less than 5% of the cost of current techniques (current Ground Penetrating Radar Techniques and InSar/LIDAR techniques range from $3,000 to $10,000), as each sensing device costs around $150 to produce. While current techniques are limited to subsidence sinkholes (sinkholes which topographically change in response to sinkhole formation over time), the methodology developed through this project is applicable to the most dangerous type of sinkhole, the cover collapse sinkhole, among other types of sinkholes, including the subsidence sinkhole. The vast applicability of the sinkhole methodology is derived from the sensing device design, which directly models the dissolution process that lies at the core of the formation of many sinkhole types. The current estimation for the implementation density of these sensing devices is one device per square mile of limestone bed. The United States Geological Survey (USGS) releases aquifer and limestone bed maps throughout the country and specifically within states such as Florida, USA. These maps indicate regions at risk to sinkhole activity. Since this detection methodology models the limestone dissolution process and utilizes a trilateration methodology, three sensing devices on average must be implemented per limestone bed. In Central Florida, USA, limestone beds have surface areas of approximately 3 mile². Implementing three sensing devices per limestone bed would approximate to one sensing device per 1 mile², however this sensing density must be tested through large-scale simulations in the future.

This project engineers the basis of a novel sinkhole detection methodology which is successful in implementation. In future work, a hypothetical example of the real-time sinkhole detection system might include scaling up sinkhole simulations and conducting field work for continued testing of the sensing device. Another embodiment of the invention might include a potential application to the Finite Element Method and the Discrete Element Method (DEM) to generate additional training data for sinkhole formation and limestone dissolution modeling.

The application of interdisciplinary applied technologies within this project resulted in the creation of a novel design, system, method, and device to introduce to the sinkhole detection field. Currently, sinkhole development, specifically cover-collapse sinkhole formation, is an environmental hazard on a global scale, affecting regions spanning from the Dead Sea coastal area to Florida, USA (Ezersky, Michael G., et al. “Overview of the Geophysical Studies in the Dead Sea Coastal Area Related to Evaporite Karst and Recent Sinkhole Development.” International Journal of Speleology, vol. 46, no. 2, May 2017, p. 277. EBSCOhost, doi:10.5038/1827-806X.46.2.2087). An optimal feature of the sensor network created through this project is its low-cost and open source software and hardware applications. These open source devices and applications allow for the flexibility of WSN and SHMS in code without expensive costs and time constraints (Salamone, Francesco, et al. “An Open Source Low-Cost Wireless Control System for a Forced Circulation Solar Plant.” Sensors (14248220), vol. 15, no. 11, November 2015, p. 27990. EBSCOhost, doi:10.3390/s151127990).

The interdisciplinary real-time detection system engineered through this project is novel in sinkhole detection and has the potential to not only reduce property damages, but more importantly, eliminate the public health threat that sinkholes pose.

A number of alternatives, modifications, variations, or improvements therein may be subsequently made by those skilled in the art, which are also intended to be encompassed by the following claims.

What is claimed is:

1. A system for real-time sinkhole detection, the system comprising:
a plurality of measuring devices including a plurality of sensors, wherein each of the plurality of sensors is configured to:
record a first type of spatial data and a second type of spatial data;
process the first type and second type of spatial data by applying a first programmed filter to obtain a third type of spatial data;
process the third type of spatial data by applying a second programmed filter to obtain a fourth type of spatial data; and
compile the first, second, third and fourth type of spatial data into a data set;
a network system configured to electronically collect a plurality of the data sets from each of the plurality of sensors;
an analysis system comprising an electronic database system and a server, wherein the server is configured to:
electronically transmit the plurality of the data sets to the electronic database system;
query the data set from the electronic database system;
process the data set by applying a machine learning algorithm to generate a real-time result about sinkhole detection;
transmit the real-time result to an interface system; and
update the electronic database system by transmitting the real-time result back to the electronic database system.

2. The system as in claim 1, wherein the first type of spatial data comprises accelerometer data, and the second type of spatial data comprises gyroscope data.

3. The system as in claim 1, wherein the third type of spatial data comprises attitude data.

4. The system as in claim 3, wherein the attitude data includes at least one of yaw, pitch and roll data.

5. The system as in claim 1, wherein the fourth type of spatial data comprises quaternion data.

6. The system as in claim 1, wherein each of the first programmed filter and the second programmed filter includes at least one of a Kalman filter and a Madgwick filter.

7. The system as in claim 1, wherein the server is configured to electronically transmit the plurality of the data sets to the electronic database system using the internet.

8. The system as in claim 1, wherein the electronic database system includes an online database system.

9. The system as in claim 1, wherein the real-time result is transmitted to the interface system through the internet.

10. The system as in claim 1, wherein the network system comprises a wireless sensor network system.

11. The system as in claim 1, wherein the machine learning algorithm is selected from the group consisting of Artificial Neural Network, Naïve Bayes Algorithm, K-Nearest Neighbor, Random Forest, and Support Vector Machines.

12. A measuring unit comprising:
a protective containment cap;
a power supply section; and
a metallic mesh section,
wherein the power supply section is positioned between the protective containment cap and the metallic mesh section, and wherein the metallic mesh section comprises a microcontroller and a sensor.

13. The measuring unit as in claim 12, wherein the metallic mesh section further comprises a waterproof container in which the microcontroller and the sensor are positioned.

14. The measuring unit as in claim 12, wherein the metallic mesh section further comprises a power supply wire connecting the waterproof container to the power supply section.

15. The measuring unit as in claim 12, wherein the metallic mesh section is filled with limestone.

16. A measuring device comprising a plurality of measuring units as recited in claim 12, wherein each of the plurality of measuring units is connected by an attachment which allows for collection of spatial data from different subterranean locations.

17. A method of detecting a sinkhole, comprising:
obtaining a measuring device comprising a plurality of measuring units each comprising
a protective containment cap, a power supply section, and a metallic mesh section, wherein the power supply section is positioned between the protective containment cap and the metallic mesh section, the metallic mesh section comprising a microcontroller and a sensor, wherein each of the plurality of measuring units is connected by an attachment configured to collect spatial data from different subterranean locations,
positioning the measuring device at a subterranean location;
collecting a plurality of data sets generated from the measuring device through a network system;
electronically transmitting the plurality of data sets to an electronic database system;
processing the plurality of data sets by applying a machine learning algorithm to generate a real-time result about sinkhole detection;
transmitting the real-time result to an interface system; and
updating the electronic database system by transmitting the real-time result back to the electronic database system.

18. The method as in claim 17, wherein the plurality of data sets include accelerometer data, gyroscope data, attitude data, and quaternion data.

19. The method as in claim 18, wherein the attitude data includes at least one of yaw, pitch and roll data.

20. The method as in claim 17, wherein the machine learning algorithm is selected from the group consisting of Artificial Neural Network, Naïve Bayes Algorithm, K-Nearest Neighbor, Random Forest, and Support Vector Machines.
